(19) United States
(12) Patent Application Publication
(10) Pub. No.: US 2015/0187127 A1
(43) Pub. Date: Jul. 2, 2015

(54) VARYING MAP CONTENT AND STYLES BASED ON TIME

(71) Applicants: Jonah Jones, San Francisco, CA (US); Bernhard Seefeld, San Francisco, CA (US); Zhou Bailiang, Balgowlah (AU)

(72) Inventors: Jonah Jones, San Francisco, CA (US); Bernhard Seefeld, San Francisco, CA (US); Zhou Bailiang, Balgowlah (AU)

(73) Assignee: GOOGLE INC., Mountain View, CA (US)

(21) Appl. No.: 13/605,035

(22) Filed: Sep. 6, 2012

Related U.S. Application Data
(60) Provisional application No. 61/673,598, filed on Jul. 19, 2012.

(51) Int. Cl. G06T 15/60

(52) U.S. Cl. CPC G06T 15/60

(57) ABSTRACT

A graphics or image rendering system, such as a map image rendering system, may restyle map features of map data based on a user time parameter. The system may retrieve map data that includes a set of map features representing physical map items wherein each map feature is associated with a style parameter. The style parameter may provide information for a map rendering device to render an appearance of the map feature and each style parameter may be assigned a default style. Modified styles may be assigned to the map data to generate responsive map data. The first modified style may include at least one display attribute different from a display attribute of the default style.

### CROSS-REFERENCE TO RELATED APPLICATIONS

This application claims the benefit of U.S. Provisional Patent Application No. 61/673,598 that was filed on Jul. 19, 2012 the disclosure of which is hereby incorporated herein by reference in its entirety for all purposes.

### FIELD OF TECHNOLOGY

The present disclosure relates to electronic map systems, and more specifically to a mapping system that adjusts map features based on time.

### BACKGROUND

A digital map is generally stored in a map database as a set of raw data corresponding to millions of streets and intersections and other map features to be displayed as part of a map. Map features may include, for example, individual roads, text labels (e.g., map or street labels), areas, text boxes, buildings, points of interest markers, terrain features, bike paths, etc. A digitally rendered map image (referred to as a digital map image) may be rendered in a number of ways. Two such methods of rendering digital map images include a raster image process and a vector image process. In a raster image process, a map image is stored within the map database as sets of rasterized or pixilated images made up of numerous pixel data points, with each pixel data point including properties defining how a particular pixel in an image is to be displayed on an electronic display device.

The vector image process uses what is traditionally called vector image data. Vector image data is typically used in high-resolution and fast-moving imaging systems, such as those associated with gaming systems, and in particular three-dimensional gaming systems. Generally speaking, vector image data (or vector data) includes data that defines specific map features to be displayed as part of an image via an image display device. Each map feature or image element is generally made up or drawn as a set of one or more triangles (of different sizes, shapes, colors, fill patterns, etc.), with each triangle including three vertices interconnected by lines. Thus, for any particular map feature, the map database stores a set of vertex data points, with each set of vertex data points defining a particular vertex of one of the triangles making up the map feature. Generally speaking, each vertex data point includes data pertaining to a two-dimensional or a three-dimensional position of the vertex (in an X, Y or an X, Y, Z coordinate system, for example) and various vertex attributes or display attributes defining properties of the vertex, such as color properties, fill properties, line width properties for lines emanating from the vertex, etc. A set of display attributes may be defined as a style. Accordingly, in the vector image process, map data may be divided into 1) data pertaining to spatial properties of map features that describe the spatial layout of a map feature and 2) style properties that determine how to render the map feature once the spatial properties are provided. During the image rendering process, the vertices and corresponding style properties defined for various map features are provided to and are processed in one or more image shaders which operate in conjunction with a graphics processing unit (GPU), such as a graphics card or a rasterizer, to produce a two-dimensional image on a display screen.

Currently, the raw map data stored in most map databases store map features without a time dependent parameter. In particular, the map features may have fixed style parameters that cannot be adjusted to correspond with time. Thus, for a given map area, map features may not reflect time based changes using existing systems. Current online maps, for example, may show the map in a time-ambivalent state, where neither map feature content nor styling of the map feature content is affected by time of day, season, or year. These time-ambivalent maps may not provide an appropriate context for a user. Map views, for example, may typically be shown in a state of perpetual daylight and summer, and points of interest are static. While these time-ambivalent maps may be useful for general navigation, they may not be appropriate to particular user contexts in which a map viewing focus may be dependent on time based information.

### SUMMARY

A computer-implemented method for providing map data to a computing device comprising receiving a request for responsive map data, the request including a user time parameter. The method retrieves map data that includes a set of map features representing physical map items wherein each map feature is associated with a style parameter. The style parameter provides information for a map rendering device to render an appearance of the map feature wherein each style parameter is assigned a default style. The method determines a set of feature categories of the set of map features, wherein the set of feature categories includes at least a general road, an area, or a location category of map features. The method assigns a single first modified style to the style parameters of the set of map features belonging to one of the feature categories based on the user time parameter to generate responsive map data. The first modified style includes at least one display attribute different from a display attribute of the default style. The method provides access to the responsive map data, wherein the responsive map data includes the assigned first modified style.

In an embodiment, a second modified style is assigned to some of the set of map features of the one feature category, wherein the first and second modified style are a subset of a total number of styles that are assignable to the one feature category. In an embodiment, the map features are ranked based on the user time parameter, and the first modified style is assigned based on a prominence rating of the first modified style wherein a degree of prominence of the first modified style increases with increasing rank of the map feature for a given time value of the user time parameter.

In an embodiment, each of the default set of map features includes a feature time parameter distinct from a style time parameter, and the map features are ranked by a time difference between the feature time parameter and the user time parameter, wherein map features having a smaller time difference are ranked higher. In an embodiment, the first modified style includes one of an angle or a direction of a display shadow of a map feature, a temperature related shade or color, or an illumination factor.

In another embodiment, a computer device includes a communications network interface, one or more processors, one or more memories coupled to the one or more processors and a display device coupled to the one or more processors. The one or more memories include computer executable instructions that are executed on the processor to receive a request for responsive map data, the request including a user time parameter. The computer executable instructions are executed to retrieve map data that includes a set of map features representing physical map items wherein each map feature is associated with a style parameter, wherein the style parameter provides information for a map rendering device to render an appearance of the map feature, and wherein each style parameter is assigned a default style. The computer executable instructions are executed to determine a set of feature categories of the set of map features, wherein the set of feature categories includes at least a general road, an area, or a location category of map features. The computer executable instructions are executed to assign a single first modified style to the style parameters of the set of map features belonging to one of the feature categories based on the user time parameter to generate responsive map data, wherein the first modified style includes at least one display attribute different from a display attribute of the default style. The computer executable instructions are executed to provide access to the responsive map data, wherein the responsive map data includes the assigned first modified style.

### BRIEF DESCRIPTION OF THE DRAWINGS

FIG. 1 is a high-level block diagram of a map imaging system that implements communications between a map database stored in a server and one or more map image rendering devices, according to an embodiment.

FIG. 2 is a high level block diagram of an image rendering engine used to render map images using map vector data, according to an embodiment.

FIG. 3 illustrates a process flow diagram of a method that may be used to assign a style to a set of map features based on a user time parameter.

FIG. 4A illustrates an embodiment of map data that may be sent to a client device.

FIG. 4B illustrates a style lookup table.

FIG. 4C illustrates an example table associating a style identifier with a set of display attributes.

FIG. 5 illustrates an example table associating a style with a time.

FIG. 6 illustrates an example table associating a map feature, a style, and a time period.

FIGS. 7A-7C illustrate map display styles corresponding to changes in shadow angle, shadow direction, and a color temperature index which varies based on time of day.

FIGS. 8A-8D illustrate a terrain map of an area that is rendered during different time periods.

FIG. 9 illustrates a data diagram associating a single map feature with multiple styles based on time.

FIG. 10 illustrates an example data diagram that may be used to construct a display schema based on time.

FIG. 11 illustrates an example data diagram in which a style parameter is associated with a prominence rating.

FIG. 12 illustrates an example table that may be used to indicate what styles are available for use with a feature category.

FIG. 13 illustrates a process flow diagram of a method that may be used to assign a style to a set of map features based on a user time parameter and based on a feature category.

FIGS. 14 and 15 illustrate display arrangements in which a map may be rendered using a first and a second display schema based on time.

FIG. 16 illustrates a data diagram of an association between a map feature parameter and a map feature time parameter.

FIG. 17 illustrates a data diagram showing a ranking of map features based on time.

FIG. 18 illustrates an evening display schema according to an embodiment.

### DETAILED DESCRIPTION

The claimed method and system generally adapts map content based on a user time parameter. An appearance of a map feature may be altered with reference to a time attribute to render maps in a much more dynamic manner. In particular, the appearance of a map feature may be altered by changing a style used to render the map feature, wherein the style includes one or more display attributes that provide information on how the map feature is to be rendered. In an embodiment, the styles may be organized by time so that an appropriate style may be selected and applied to a map feature based on a user time parameter. Generally, adjusting styles of map features based on time may tailor the appearance of map content to provide a more aesthetically pleasing user experience that corresponds with a user's current situation. Moreover, styling the map features based on time may provide additional time-relevant information that may be important to a user's focus (e.g., search context) that would otherwise be unavailable or difficult to ascertain.

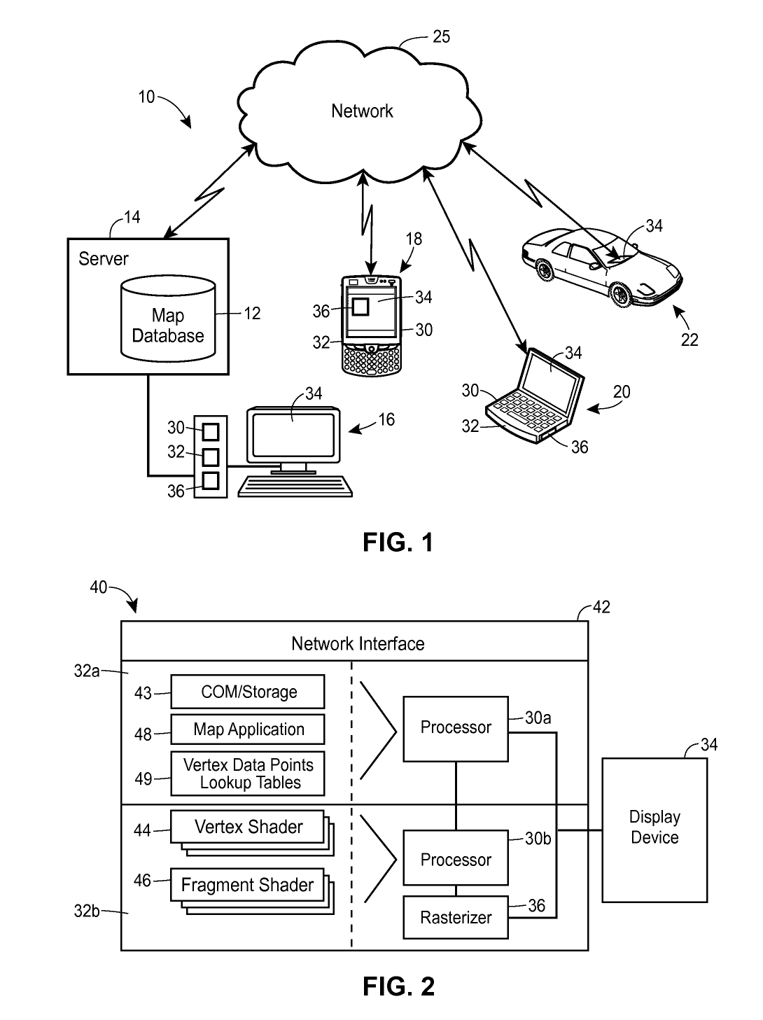

Generally, FIGS. 1-3 describe one or more systems that may be used to implement a mapping system as described herein. Referring now to FIG. 1, a map-related imaging system 10, according to an embodiment, includes a map database 12 stored in a server 14 or in multiple servers located at, for example, a central site or at various different spaced apart sites, and also includes multiple map client devices 16, 18, 20, and 22, each of which stores and implements a map rendering device or a map rendering engine. The map client devices 16-22 may be connected to the server 14 via any hardwired or wireless communication network 25, including for example a hardwired or wireless local area network (LAN), metropolitan area network (MAN) or wide area network (WAN), the Internet, or any combination thereof. The map client devices 16-22 may be, for example, mobile phone devices (18), computers such a laptop, tablet, desktop or other suitable types of computers (16, 20) or components of other imaging systems such as components of automobile navigation systems (22), etc. Moreover, the client devices 16-22 may be communicatively connected to the server 14 via any suitable communication system, such as any publically available and/or privately owned communication network, including those that use hardwired based communication structure, such as telephone and cable hardware, and/or wireless communication structure, such as wireless communication networks, including for example, wireless LANs and WANs, satellite and cellular phone communication systems, etc.

The map database 12 may store any desired types or kinds of map data including raster image map data (e.g., bitmaps) and vector image map data. However, the image rendering systems described herein may be best suited for use with vector image data which defines or includes a series of vertices or vertex data points for each of numerous sets of image objects, elements or primitives within an image to be displayed. Generally speaking, each of the image objects defined by the vector data will have a plurality of vertices associated therewith and these vertices will be used to display a map related image object to a user via one or more of the client devices 16-22. As will also be understood, each of the client devices 16-22 includes an image rendering engine having one or more processors 30, one or more memories 32, a display device 34, and in many cases a rasterizer or graphics card 36 which are generally programmed and interconnected in known manners to implement or to render graphics (images) on the associated display device 34. The display device 34 for any particular client device 16-22 may be any type of electronic display device such as a liquid crystal display (LCD), a light emitting diode (LED) display, a plasma display, a cathode ray tube (CRT) display, or any other type of known or suitable electronic display.

Generally, speaking, the map-related imaging system 10 of FIG. 1 operates such that a user, at one of the client devices 16-22, opens or executes a map application (not shown in FIG. 1) that operates to communicate with and obtain map information or map related data from the map database 12 via the server 14, and that then displays or renders a map image based on the received map data. The map application may allow the user to view different geographical portions of the map data stored in the map database 12, to zoom in on or zoom out of a particular geographical location, to rotate, spin or change the two-dimensional or three-dimensional viewing angle of the map being displayed, etc. More particularly, when rendering a map image on a display device or a display screen 34 using the system described below, each of the client devices 16-22 downloads map data in the form of vector data from the map database 12 and processes that vector data using one or more image shaders to render an image on the associated display device 34.

Referring now to FIG. 2, an image generation or imaging rendering device 40, according to an embodiment, associated with or implemented by one of the client devices 16-22 is illustrated in more detail. The image rendering system 40 of FIG. 2 includes two processors 30a and 30b, two memories 32a and 32b, a user interface 34 and a rasterizer 36. In this case, the processor 30b, the memory 32b and the rasterizer 36 are disposed on a separate graphics card (denoted below the horizontal line), although this need not be the case in all embodiments. For example, in other embodiments, a single processor may be used instead. In addition, the image rendering system 40 includes a network interface 42, a communications and storage routine 43 and one more map applications 48 having map display logic therein stored on the memory 32a, which may be executed on the processor 30a (e.g., which may be a central processing unit (CPU)) Likewise one or more image shaders in the form of, for example, vertex shaders 44 and fragment shaders 46 are stored on the memory 32b and are executed on the processor 30b. The memories 32a and 32b may include either or both volatile and non-volatile memory and the routines and shaders are executed on the processors 30a and 30b to provide the functionality described below. The network interface 42 includes any well known software and/or hardware components that operate to communicate with, for example, the server 14 of FIG. 1 via a hardwired or wireless communications network to obtain image data in the form of vector data for use in creating an image display on the user interface or display device 34. The image rendering device 40 also includes a data memory 49, which may be a buffer or volatile memory for example, that stores vector data received from the map database 12, the vector data including any number of vertex data points and one or more lookup tables as will be described in more detail.

During operation, the map logic of the map application 48 executes on the processor 30 to determine the particular image data needed for display to a user via the display device 34 using, for example, user input, GPS signals, prestored logic or programming, etc. The display or map logic of the application 48 interacts with the map database 12, using the communications routine 43, by communicating with the server 14 through the network interface 42 to obtain map data, preferably in the form of vector data or compressed vector data from the map database 12. This vector data is returned via the network interface 42 and may be decompressed and stored in the data memory 49 by the routine 43. In particular, the data downloaded from the map database 12 may be a compact, structured, or otherwise optimized version of the ultimate vector data to be used, and the map application 48 may operate to transform the downloaded vector data into specific vertex data points using the processor 30a. In one embodiment, the image data sent from the server 14 includes vector data generally defining data for each of a set of vertices associated with a number of different image elements or image objects to be displayed on the screen 34 and possibly one or more lookup tables which will be described in more detail below. If desired, the lookup tables may be sent in, or may be decoded to be in, or may be generated by the map application 48 to be in the form of vector texture maps which are known types of data files typically defining a particular texture or color field (pixel values) to be displayed as part of an image created using vector graphics. More particularly, the vector data for each image element or image object may include multiple vertices associated with one or more triangles making up the particular element or object of an image. Each such triangle includes three vertices (defined by vertex data points) and each vertex data point has vertex data associated therewith. In one embodiment, each vertex data point includes vertex location data defining a two-dimensional or a three-dimensional position or location of the vertex in a reference or virtual space, as well as an attribute reference. Each vertex data point may additionally include other information, such as an object type identifier that identifies the type of image object with which the vertex data point is associated. The attribute reference, referred to herein as a style reference or as a feature reference, references or points to a location or a set of locations in one or more of the lookup tables downloaded and stored in the data memory 43.

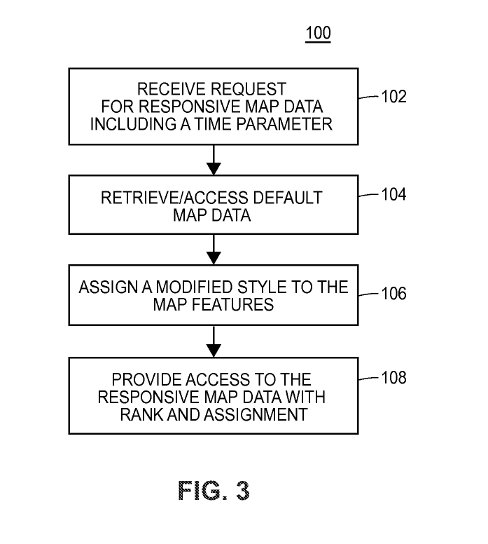

FIG. 3 illustrates a process flow diagram or flow chart of a method, routine, or process 100 that may be used to manipulate map data, according to an embodiment. In any event, a block 102 may receive a request for responsive map data, the request including a user time parameter. A block 104 may retrieve map data that includes a set of map features representing physical map items. Each map feature of the set may be associated with a style parameter. The style parameter may provide information on how a rendering device is to render an appearance of the map feature. In an embodiment, each style parameter may be assigned a default style. A block 106 may assign a modified style to the style parameter of at least one of the retrieved map features based on the user time parameter, thereby generating responsive map data. The modified style may include at least one display attribute different from a display attribute of the default style. A block 108 may provide access to the responsive map data, wherein the responsive map data includes the assigned modified style. In an embodiment, an additional block 110 (not shown) may render the restyled map data on a display device.

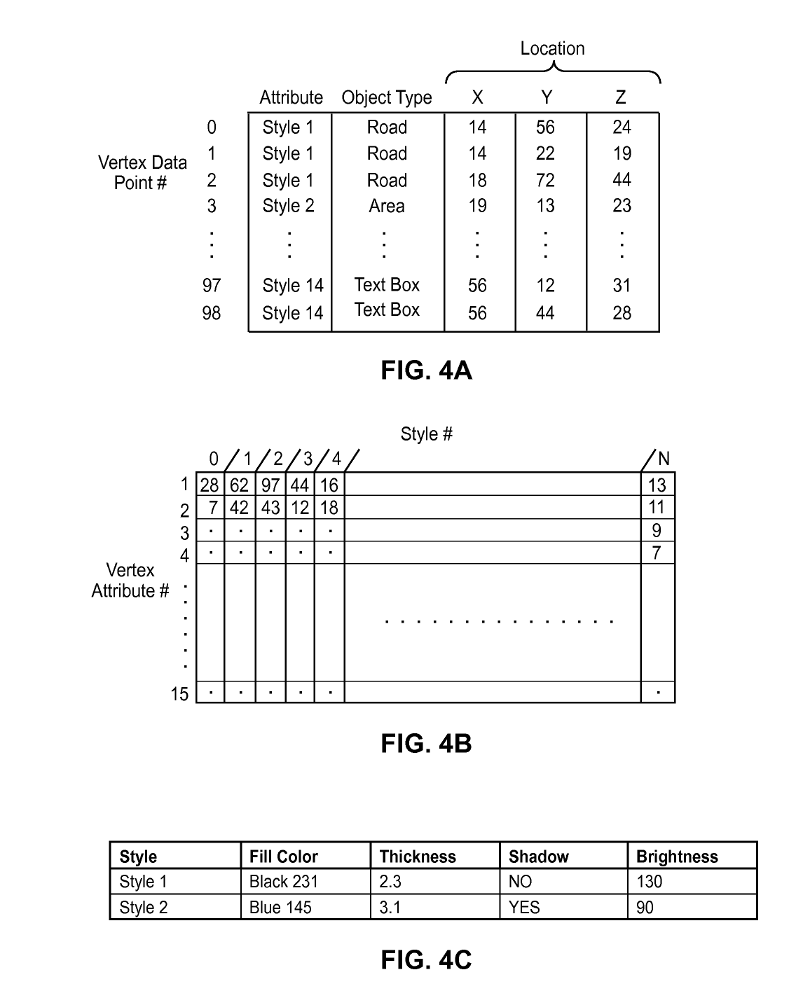

To restyle map features based on the process of FIG. 3, map data may be structured in a number of manners to enable an efficient storage and retrieval of the map data for use with the claimed method and system. Generally, the following descriptions describe data structures that may be used to implement or assemble all or some of the data used by the claimed method and system. In particular, the FIGS. 4A-4C, 5, 6, 9, 10-12, 16 and 17 illustrate data diagrams or data structures (in table form) which those skilled in the art can readily implement in a number of manners such as, for example, database tables, memory pointers associating one or more data parameters, etc. Thus, while the data diagrams are depicted in table form, those skilled in the art readily understand that the data diagrams can be implemented in any number of ways to organize and manage data in a manner consistent with the techniques described herein.

FIG. 4A illustrates an embodiment of map data that may be sent to a client device, such as device 40 of FIG. 2, for processing, according to an embodiment. As FIG. 4A illustrates, map data contains location data for a vertex, an object type, and a style attribute(s) for the vertex. A set of one or more of the vertices may comprise a map image object or map feature, such as a road or a building. The style attributes may be sent for each vertex or may reference a style look up table such as that illustrated in FIG. 4B that can be used to decode a style reference from FIG. 4A into a complete set of one or more style attribute values, according to an embodiment.

Map features may include, for example, individual roads, text labels (e.g., map or street labels), areas, text boxes, buildings, points of interest markers, terrain features, bike paths, etc. Map features may be divided into features that represent actual physical items on a map surface such as roads, areas, and locations as well as map features that do not represent actual physical items, such as text labels and text boxes. In some embodiments, the claimed method and system may apply to only some map features or types of map features. For example, the claimed method and system according to one embodiment, may only apply to styling to a subset of map features such as those representing actual physical items.

A style may be defined as a set of display attributes or parameters that are used to determine the appearance of a map feature. A style may include a fill color (e.g., for area objects), an outline color, an outline width, an outline dashing pattern and an indication of whether to use rounded end caps (e.g., for road objects), an interior color, an interior width, an interior dashing pattern, and interior rounded end caps (e.g., for road objects), a text color and a text outline color (e.g., for text objects), an arrow color, an arrow width, an arrow dashing pattern (e.g., for arrow objects), a text box fill color and a set of text box outline properties (e.g., for text box objects) to name but a few. Of course, different ones of the vertex display attributes (or simply display attributes) provided may be applicable or relevant to only a subset of image objects or map features and thus the vertex style data points associated with a particular type of image object may only refer to a subset of the vertex attributes listed for each style. Alternatively, some styles may only be assignable to a particular image object or map feature based on the type of map feature. For example, road styles may be assignable only to road map features while area styles may be assignable only to area map features. In an embodiment, a style may reference one or more images such as a raster image or bitmap. The image may be used to render at least a portion of a map feature and/or may represent a style of the map feature. A display attribute of a style parameter may reference the image thereby associating the style to the image. The image may be, for example, a symbol representing a map feature, a portion of a map feature, or a type of a map feature. In an embodiment, the image may be a symbol or other label used to identify the map feature.

Generally speaking, the techniques for restyling or adjusting the appearance of map features may organize a set of styles based on a time parameter. These styles may then be assigned to map features of map data to adapt the map data to the user time parameter. Restyling the map data based on time may enable a map rendering system to provide time-based distinctions in map features that not only enhance a user experience by increasing map aesthetics, but provide additional context data to a map display so that a user may, for example, sort map data more efficiently or make better informed decisions on navigation and map feature searching based on time.

FIG. 4C illustrates a data diagram (in table form) associating a style identifier with a set of display attributes. The table of FIG. 4C is similar to the lookup table of FIG. 4B except that examples of particular style attribute values are described (e.g., color, thickness, labeling). It should be noted that FIG. 4B displays only some example values of display attributes that can be assigned or associated with a style. Generally, a style (represented by a style identifier) may be defined as a set of display attributes or parameters, where each display parameter has a value. A style may be changed or modified by changing a value of a display parameter that is associated with the style and/or by changing the display parameters of the style. For example, the style may be changed by removing display attributes previously associated with a style identifier or associating additional display attributes with the style identifier. In an embodiment, only existing styles that are already associated with map features of map data may be assigned to the map features. In this manner, the assignment of styles may be performed by re-assigning existing style identifiers already contained in the map data. The use of existing styles may be more applicable in map rendering systems that are difficult to modify. Where an existing map rendering system already contains a large number of pre-defined styles, adaptation of a new display schema (to be discussed further below) may be relatively easier to implement. Alternatively, the method and device described herein may use a set of style parameters that is different and distinct from any styles previously assigned to the map features of the map data. As discussed, a new style may be created by modifying existing display parameters or attributes of existing styles or creating new sets of display parameters and attributes. Using a different and distinct set of new styles may create a more significant distinction, where needed, in the rendering of the restyled map features.

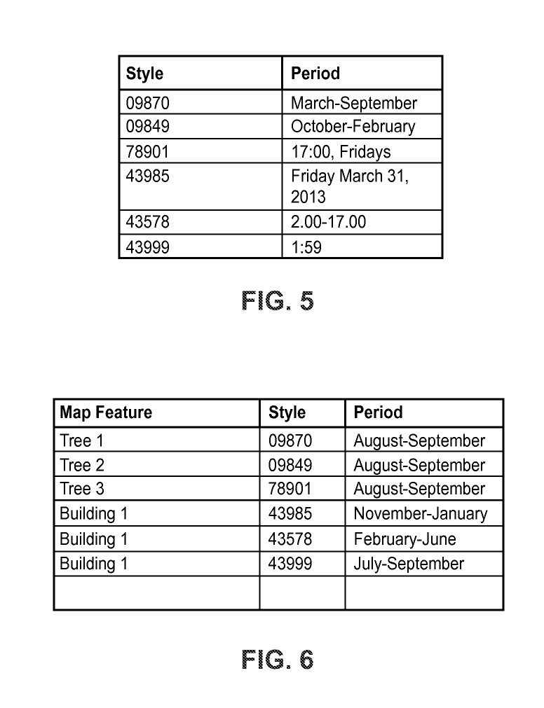

FIG. 5 illustrates a data diagram (in table form) associating a style with a time. Similar to other data diagrams described herein, the descriptive values shown in the data columns could also be codified as numerical or alphanumerical identifiers such as those of FIG. 4B or vice versa. Each style value of FIG. 5 may have a corresponding set of display parameters such as those illustrated in FIGS. 4A-4C. The table of FIG. 5 illustrates that a style may be assigned to any number of time values including month long periods, weekly periods, daily events, specific points in time, etc. The table of FIG. 5 may be used to select an appropriate style for a map feature based on matching the time values of FIG. 5 with a value of a user time parameter (to be discussed further below).

A user time parameter may generally indicate a current time or time period in which the user is operating a map rendering device to view one or more maps. In this situation, a current time or time period may be used to find relevant map data that is used to render map features. In an embodiment (to be described further below), the user time parameter may be a user adjustable or a user settable time. Corresponding map feature and style data may be retrieved based on the user set time. For example, where style data is organized according to the data associations of FIG. 5, a style(s) matching the user set time may be retrieved and used by a rendering engine to render the appearance of a given map feature for the specific user set time. This may enable the user to view map feature content in a manner relevant to a future or a past time period. Some applications of this restyling may become apparent. For example, a user currently navigating a city during daytime may desire to understand how navigation may be affected at night and adjust the user time setting to a future nighttime period. Similarly, a user may desire to understand how navigation by a third party may have been affected by time of day at an earlier or historic time period. The above user contexts may be supported by the method and system described herein.

FIG. 6 illustrates a data diagram associating a map feature, a style, and a time period. An appearance of a map feature may be adjusted based on the described techniques by modifying the style associated with the map feature. Generally, a set of styles may be relevant for a specified time or period and less relevant for other times or periods. The relevance of styles may depend on how actual physical map features generally change in appearance over time. Thus, given a map feature such as a building (e.g., Building 1 of FIG. 6), whose appearance (i.e., the manner in which the building is rendered) may be related to a time of day, different styles may be assigned based on the time of day, where the styles may be organized by a table such as that of FIG. 6.

In an embodiment, retrieved map data (e.g., of block 102) may have a set of map features with a set of default styles associated with the map features. In this case, the map features may be restyled (i.e., reassigned a new or modified style) based on time. The assignment may result in a data association such as those in FIG. 6. In an embodiment where map data contains map features that do not have an initial style assignment or association, styles may be dynamically assigned by using, for example, the data relationships of FIG. 5. to produce the data associations of FIG. 6.

In an embodiment, a table such as that of FIG. 6 may indicate that a set of styles are only relevant to certain map features. For example, the Building 1 of FIG. 6 has three styles that are assigned to it, but with varying time designations. The three styles may be assigned only to a building type or only to a particular building. A map rendering system may determine first which styles are assignable to a particular map feature(s) and only render a map feature using the corresponding style based on time according to the table of FIG. 6. In an embodiment, a first data table may be used to determine which styles may be assigned to a particular map feature (based on time), while a second data table may be used to capture a current assignment of a style to a map feature.

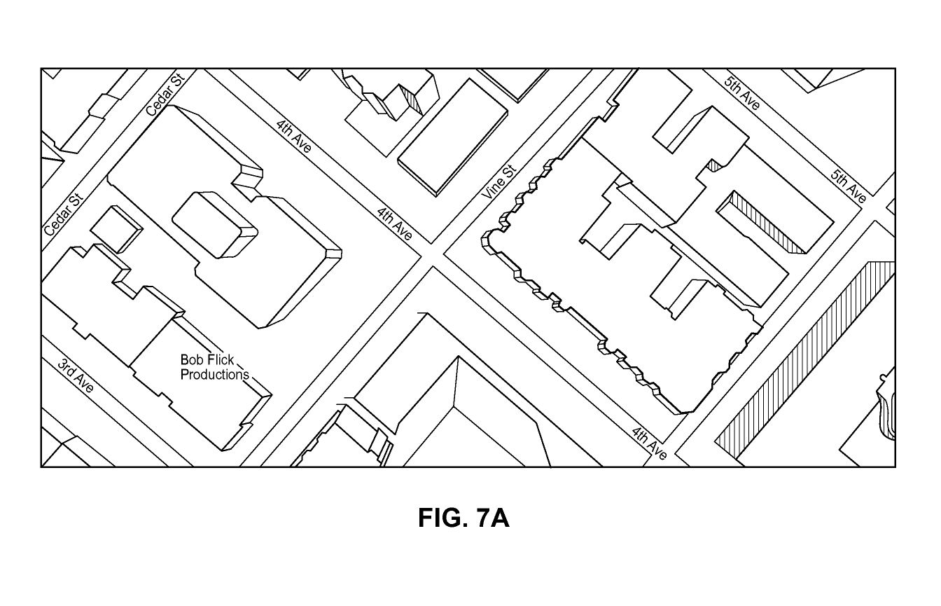

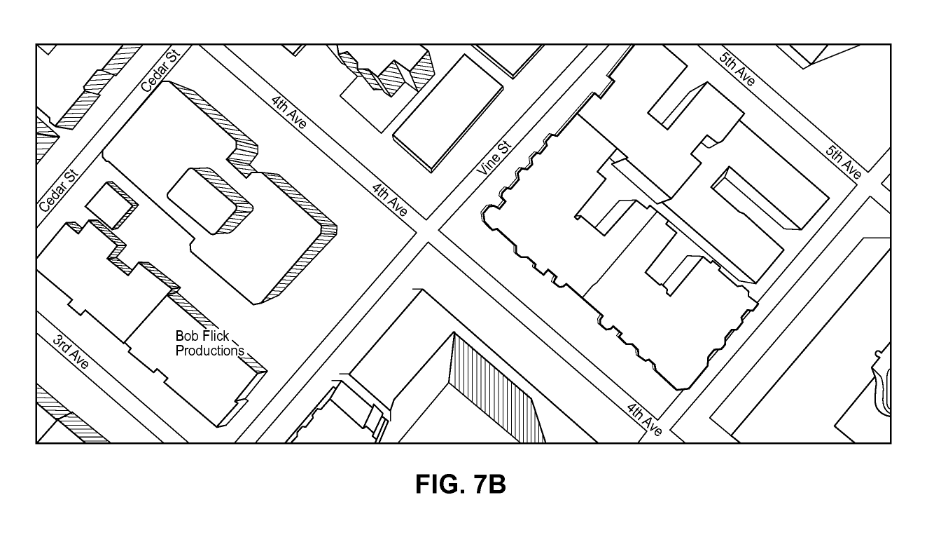

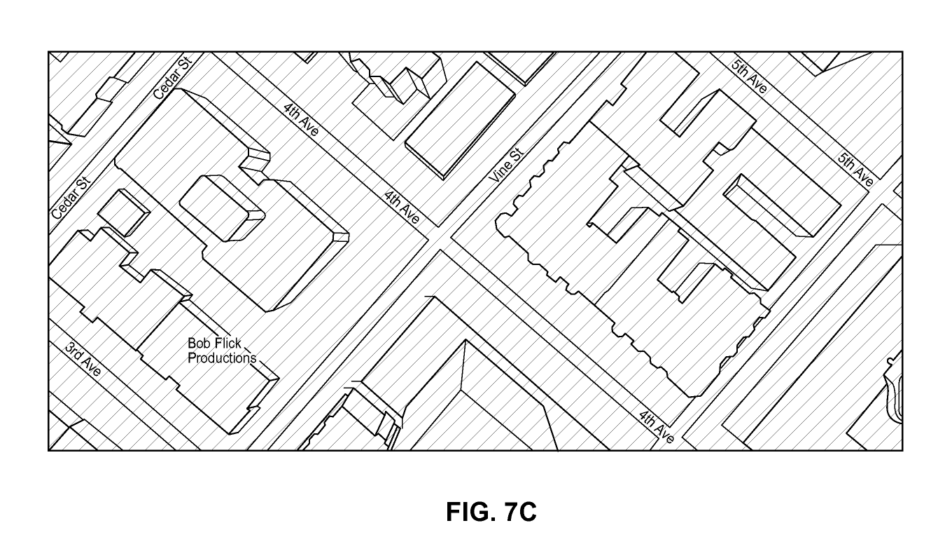

FIGS. 7A-7C illustrate maps highlighting style changes that relate to how a building or other three-dimensional map feature may be rendered based on time. In particular, FIGS. 7A-7C displays styles that relate to shadow angle, shadow direction, and a color temperature index which varies based on time of day. FIG. 7A illustrates a morning rendering of map building features in which shadow angles and directions correspond with early morning light from the east and a cool light temperature. FIG. 7B illustrates shadow angles and directions that correspond with early evening light (around 6 pm) coming from the west and showing longer shadows and a warm light temperature. FIG. 7C illustrates an evening display of the buildings of FIGS. 7A and 7B indicating subtle moon shadows and a cool light temperature. Generally, for any three-dimensional map feature, such as the buildings of FIGS. 7A-7C, a corresponding style may be assigned to the three-dimensional map feature based on time, where the style's display parameters include a shadow angle, a shadow direction, and a color temperature index (may be indicated using color or a shade), just to name a few.

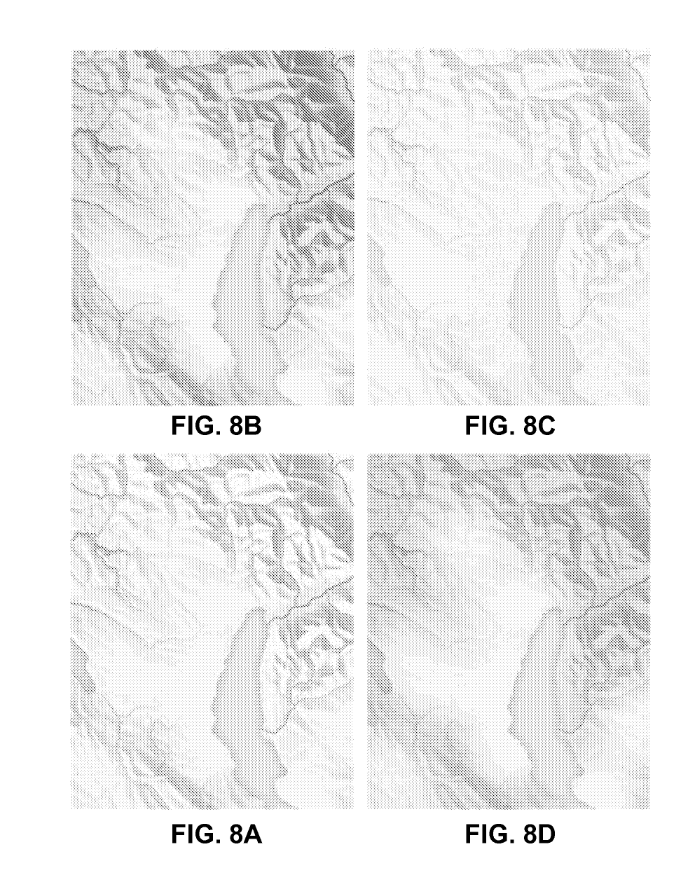

FIGS. 8A-8D illustrate a terrain map of an area that is rendered during different time periods. The different time periods may represent style and/or feature changes based on different periods of a year (i.e., seasons). The styles illustrated in FIGS. 8A-8D may change a shading parameter as well as a color index parameter to indicate a time of year. The style differences of FIGS. 8A-8D may be used, for example, to indicate a season. In an embodiment, FIG. 8A may represent a moderate climate period such as a spring season, FIG. 8B may represent a lush and moist summer period, FIG. 8C may represent a cold winter period, and FIG. 8D may represent a hot and arid season, such as fall period. Alternatively, FIGS. 8A-8D may represent renderings of the map area based on longer periods of time (e.g., over decades).

In FIGS. 8A-8D, map feature styles may be changed alone based on time or a combination of both map features and corresponding styles may be changed based on time. In an embodiment where raster images are used, a map image of an area representing a baseline map image (in bitmap form) may be supplemented with additional feature or style information that is drawn on top of the raster image. In an embodiment, additional raster images or bitmap images of a rendered area may replace the baseline map image based on time. In a hybrid mapping embodiment where both raster images and vector drawings are used, a raster image may be used to render a baseline map image and additional features and/or style information may be superimposed using vector drawings. Accordingly, the map renderings illustrated in FIGS. 8A-8D may be rendered using a plurality of raster images or a combination of raster images and vector drawings based on time.

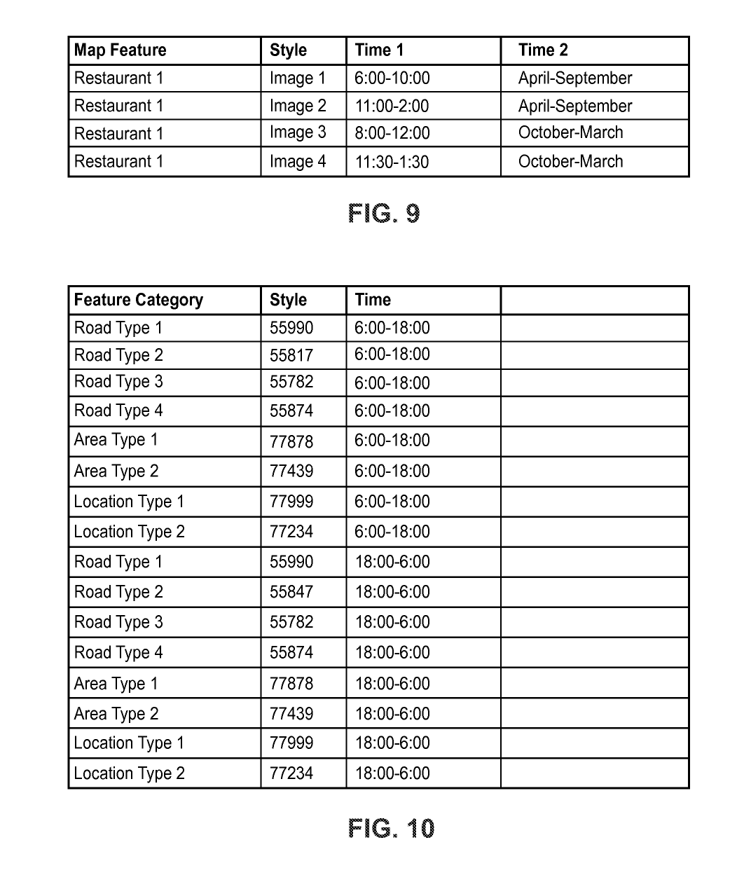

As discussed above, the style parameter may be used to determine how additional image data may be used to render the appearance of a map feature. For example, when drawing additional vector based map features, a style associated with a map feature may have one or more display attributes indicating what graphical elements may be added to provide the map feature with a particular appearance or style based on time. FIG. 9 illustrates a data diagram associating a map feature, a style, and two time parameters. FIG. 9 illustrates that a map feature such as a restaurant business may have several images that are associated with a single map feature (e.g., a building) based on time. In an embodiment, the style parameters may indicate how to render the building based on time. For example, the data diagram of FIG. 9 may be used to render the displays of FIGS. 7A-7C.

In an embodiment, a display schema may be used to assign styles to map features based on time. A display schema is defined as a set of styles that are associated with a set of feature categories, where the set of styles may correspond to a time or a time period. A feature category may be any set of map features that may be associated with each other. Some examples of map feature categories or feature types may be roads, areas, or point locations. Map feature categories may be more specific (e.g., categories may have subcategories) such as highways, streets, and alleys, parks, monuments, restaurants, post offices, etc., to name a few. A display schema may be used to render an area of a map in a manner that not only indicates time, but also shows how a set of map features relate with each other based on time. The following figures illustrate how display schemas may be organized and implemented.

FIG. 10 illustrates a table that may be used to construct a display schema based on time. FIG. 10 illustrates that a first display schema includes four road types (Road Types 1-4), two area type (Area 1-2), and two location types (Location Types 1-2), all of which correspond to a time period of 6:00-18:00. Each of the map feature categories is associated with a corresponding style. A second display schema includes the same feature categories but with different style assignments for a different time period of 18:00-6:00. The first display schema may be a daytime display schema associated with time 6:00-18:00 while the second display schema may be a nighttime display schema associated with time 18:00-6:00. FIG. 10 is illustrative only and one skilled in the art will understand that the data associations may be implemented in a number of ways. For example, each display schema may be organized into separate tables, wherein each table corresponds to a particular time period, thereby reducing the need to include a time parameter with each display style and feature category.

In an embodiment utilizing a time-based display schema, assigning a style to a map feature category may include assigning all map features belonging to that category a default style. In this case, a particular map feature that needs to be contrasted may have its default style overwritten with a new modified style. Many factors may contribute to whether a selection or subset of the features in a particular category may be assigned a different style instead of the default category style. For example, particular map features may be highlighted (i.e., assigned a different style other than a default style) to intentionally draw out a contrast between the selected map feature and other map features belonging to the highlighted map feature's category.

In an embodiment of a display schema, assigning a map feature category a style may include assigning map features belonging to the feature category a restricted subset of style parameters or a restricted range of style parameters. A map feature category, such as a road, may already have a limited number of styles that are applicable to the map feature. For example, a road may not be assigned a style for a building because the two styles are exclusive to their feature category. However, by restricting the range of styles that are available or assignable to a map feature category, a visual contrast or distinction may be conveyed between how a feature is generally rendered with time based information and how a feature is rendered without time-based information. In an embodiment, the restricted range of style parameters may include styles that are defined by the same set of display parameters but with different values for some of the display parameters. For example, only a single color attribute may differ between the range of styles assigned to a map feature category. A nighttime display schema, for example, may have all roads colored black, while a daytime display schema may have all roads colored yellow where all other display parameters for the road styles remain constant.

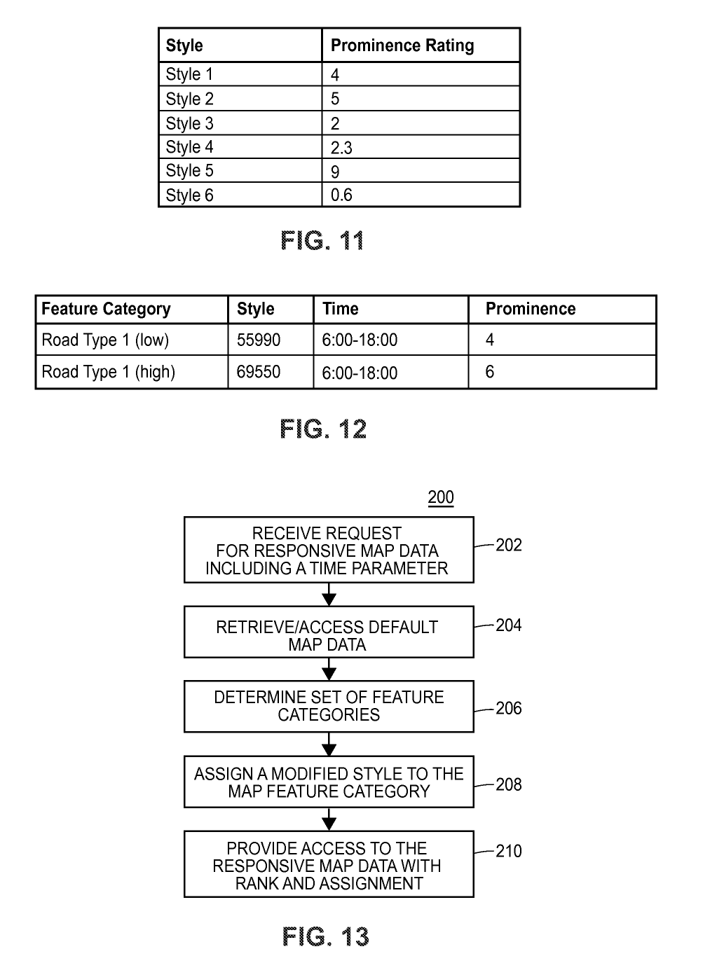

In an embodiment, the restricted subset of style parameters that may be assigned to a feature category, as defined by a display schema, may be based on a prominence rating of the subset of styles. Generally, style parameters may be used to distinguish different map features via a difference in display prominence of a style. A degree of prominence or a prominence rating may be determined based on a number of different factors, but generally refer to a degree of visual difference between styles (i.e., contrast). FIG. 11 illustrates an example data diagram in which a style parameter is associated with a prominence rating, indicating a degree of prominence, where a higher number indicates a higher prominence. In some embodiments, a user may determine prominence ratings manually, whereby the ratings of the styles in FIG. 11 may be inputted or set by the user. In some embodiments, the prominence rating may be determined based on differences in measurable values of certain display parameters. For example, the prominence rating may be calculated based on a degree of brightness of a style, a degree of color of a style, a size of a style, or any combination of such factors or attribute values. In one embodiment, an algorithm may be used to calculate an overall prominence level based on a combination of display parameter values. The algorithm may generally assign weights to one or more display parameters and calculate a weighted average of the values of the display parameters to determine a prominence rating of the style.

The claimed method and system may use a display schema to define a subset of styles that can be assigned to a map feature category based on a prominence range of the styles that are assignable to the map feature category. For example, a display schema may determine that the styles used to render road features at night should have prominence ratings in a range of 4-9. Thus, if the styles of FIG. 11 are applicable to road features, only styles 1, 2, and 5 can be used for the described display schema. A data diagram such as FIG. 12 may be used to indicate that two or more styles are available for use in a feature category. In particular, FIG. 12 shows that at a given time, a style 55990 having a low prominence of 4 may be used to render some roads (e.g., low priority roads) of a feature category (i.e., Road Type 1), while a style 69550 having a high prominence of 6 may be used to render other roads (e.g., high priority roads) of the same category. Effectively, the range of possible road styles is limited to styles having a prominence of 4 or 6.

FIG. 13 illustrates another process flow diagram or flow chart of a method, routine, or process 200 that may be used to manipulate map data, according to an embodiment. In any event, a block 202 may receive a request for responsive map data, the request including a user time parameter. A block 204 may retrieve map data that includes a set of map features representing physical map items wherein each map feature is associated with a style parameter, wherein the style parameter provides information for a map rendering device to render an appearance of the map feature, and wherein each style parameter is assigned a default style. A block 206 may determine a set of feature categories of the set of map features, wherein the set of feature categories include at least a general road, an area, or a location category of map features. A block 208 may assign a first modified style to the style parameters of the set of map features belonging to one of the feature categories based on the user time parameter to generate responsive map data, wherein the first modified style includes at least one display attribute different from a display attribute of the default style. A block 210 may provide access to the responsive map data, wherein the responsive map data includes the assigned first modified style.

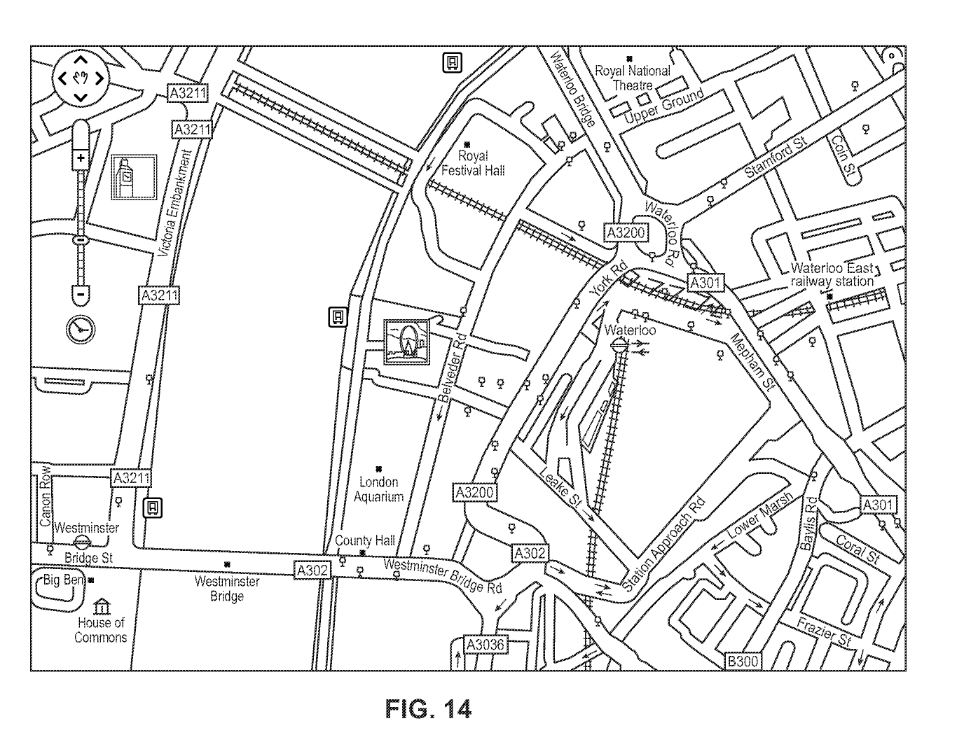

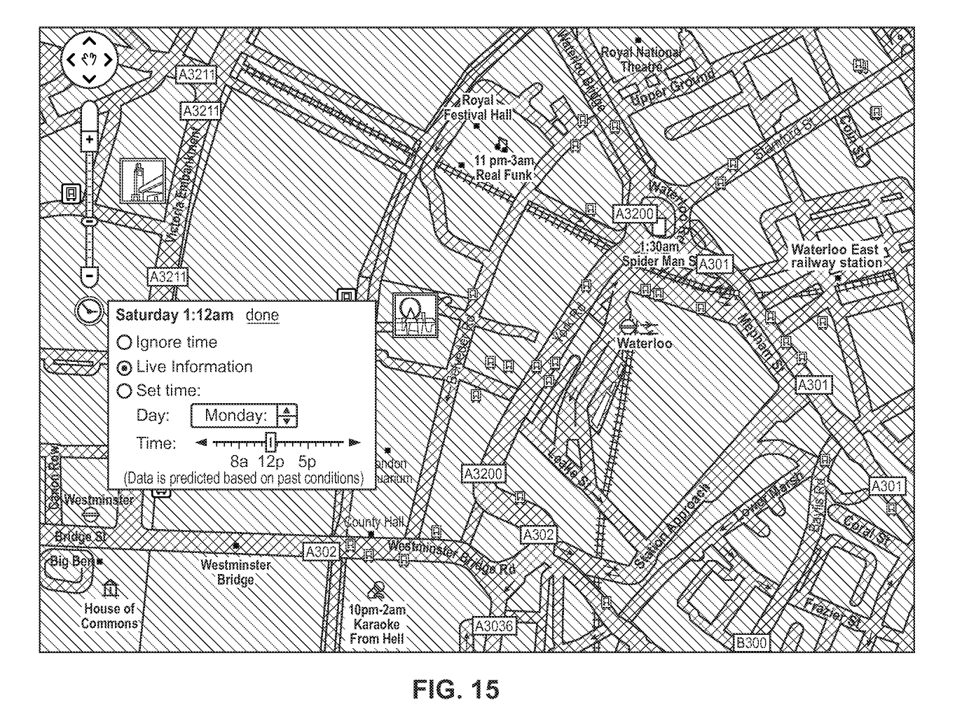

FIGS. 14 and 15 illustrate display arrangements in which a map may be rendered using a first and a second display schema, respectively, where the first display schema of FIG. 14 may correspond to a day time period and the second display schema of FIG. 15 may correspond to a night time period. FIGS. 14 and 15 illustrate that map features that are common to the two time periods may be rendered using a different style. In an embodiment, a different color set may correspond with or may be used to indicate a time period of the rendering. In particular, the display schema embodiment illustrated in FIG. 15 uses different tints, shades and tones of blue and black color combinations to represent a night time period. In an embodiment, roads and other paths may be designated using black color while other general map areas may be represented by blue color. Labels associated with various map features may be rendered in different tints, shades and tones of white. Symbol labels may retain a default rendering pattern (see London Tube symbol) but be highlighted using a color (white in FIG. 15) tint, shade, and or tone based on the display schema of FIG. 15. While FIGS. 14 and 15 illustrate display schemas for daytime and nighttime, other display schemas may be used to indicate or correspond with other periods of the day such as afternoon and early morning that are different from the display schemas of FIGS. 14 and 15.

FIGS. 14 and 15 also illustrate that some features that may be present in the daytime rendering of FIG. 14 may not be present in the nighttime rendering of FIG. 15 and vice versa. In an embodiment, information on the map features that should be displayed may be retrieved from a data table based on data associations such as those illustrated in FIG. 16.

FIG. 16 illustrates a data diagram of an association between a map feature parameter and a feature time parameter. The data diagram of FIG. 16 may be used to determine which map features are to be displayed based on matching the time of the map feature to the user time parameter. This may be applicable to map features that may not exist at certain times. Also, selection of a limited number of map features (e.g., point locations) may be helpful in situations in which map area is limited for a given magnification. Generally, a map feature may have an associated time or time period that is relevant to that map feature. For example, a map feature such as a restaurant may have hours of operation in which the restaurant is open for business. In an embodiment, map features that do not correspond may not be displayed. In an embodiment, characteristics of the map features may be expressed using style changes without necessarily foregoing the display of the map feature. For example, in situations in which a map feature such as a restaurant may not be in operation, the map feature may be styled to indicate that it is not in operation, rather than excluding the map features from the display. The time period(s) associated with the map features may be recurring characteristics of a physical object, location, or area or may be nonrecurring. FIG. 16 captures a first period parameter that may indicate a daily recurring time period that is relevant to the map feature and a second period parameter which may indicate a different period range that is relevant to the map feature. Of course, while the embodiment of FIG. 16 illustrates two separate time parameters, a single time parameter may be used to indicate multiple time periods.

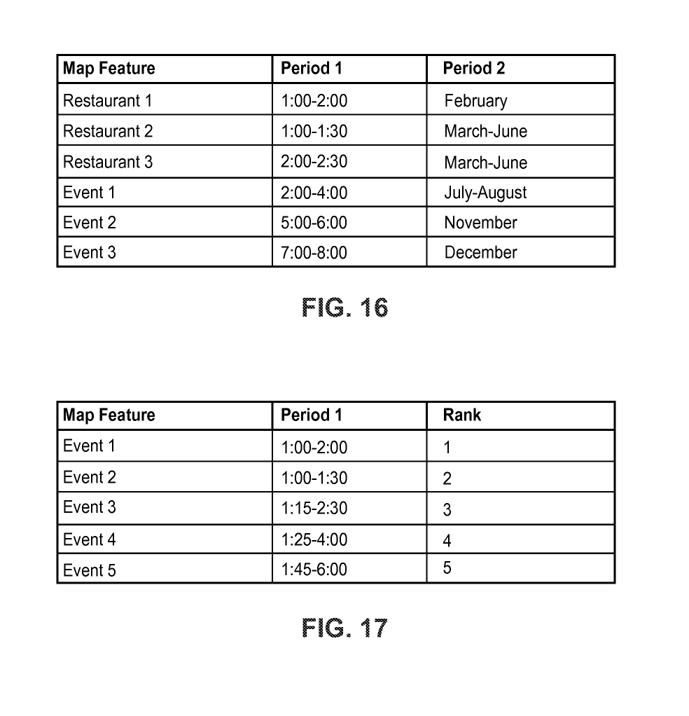

Generally, a map feature corresponding to a physical item on a map (e.g., a road, an area, or a location) may be associated with one or more events, being ancillary map features that do not represent an actual physical item. The events may include, for example, hours of operation or, in the case of an entertainment venue such as a theater or concert park, one or more performances or shows. FIG. 16 illustrates that one or more events of a point location may be associated with a corresponding time. According to an embodiment, both the selection of a map feature and a styling of the map feature may be based on time. In this case, the table of FIG. 16 may be used to determine which events to render (e.g., as a label) on a map. Because of the limited size of a map area, some map items, especially those map items that do not represent physical items, may not fit on an existing map. Where there are more ancillary map features (e.g., labels) than space on the map for display, a ranking system may be implemented to determine how the ancillary map features may be displayed. For example, in an embodiment, when a plurality of event labels are to be displayed on the same area of a map, the event labels may be ranked based on a difference of an event time to a user time parameter. The events that have a smaller difference from the user time parameter may be ranked higher. FIG. 17 illustrates a data diagram showing a ranking based on time. A table based on the data diagram of FIG. 17 may be used to determine which labels may be rendered based on time and space on the map. Thus, for example, where a user time parameter (e.g., a current user time) corresponds to five events for a particular point location, only three of the top ranked events may be displayed based on space consideration.

In an embodiment, the ranking may be used to determine a corresponding style for rendering the selected map features. In particular a style may be assigned to selected map features based on an assigned rank. In an embodiment, higher ranked map features may be assigned styles that have a higher degree of prominence or higher prominence rating (see description above). In an embodiment in which a display schema restricts the range of assignable styles, the restricted set of styles may be applied based on matching prominence and rank. Thus, where a restricted set of styles for a point location is limited to a style having a prominence of 3 and a style having a prominence of 4.5, the style with prominence 4.5 may be assigned to high ranked map features in the selected set of map features and the style with prominence 3 may be assigned to low ranked features of the set. It should be noted that the map features of FIG. 7 may be ranked based on numerous time schemes as well as non-time based criteria.

Returning to FIG. 15, a time-based widget is displayed on the map. In an embodiment, the time-based widget may simply indicate a current time in which the map is based on. In some embodiments, the time indicator may be adjustable. The time indicator may be adjusted to a particular time value and the map may be rendered accordingly based on the user selected time value. In an embodiment, only styles of map features may be effected by adjusting time. In an embodiment, map features may also change by adjusting time. For example, a user wishing to view when businesses are open around a neighborhood may adjust the time-based widget to various times to view time-based maps or map-related images. In some embodiments, the selection of a time or period may retrieve a corresponding raster image of an area corresponding to the selected time. For example, a user may cause different sets of satellite imagery or other area photos based on a selected time value.

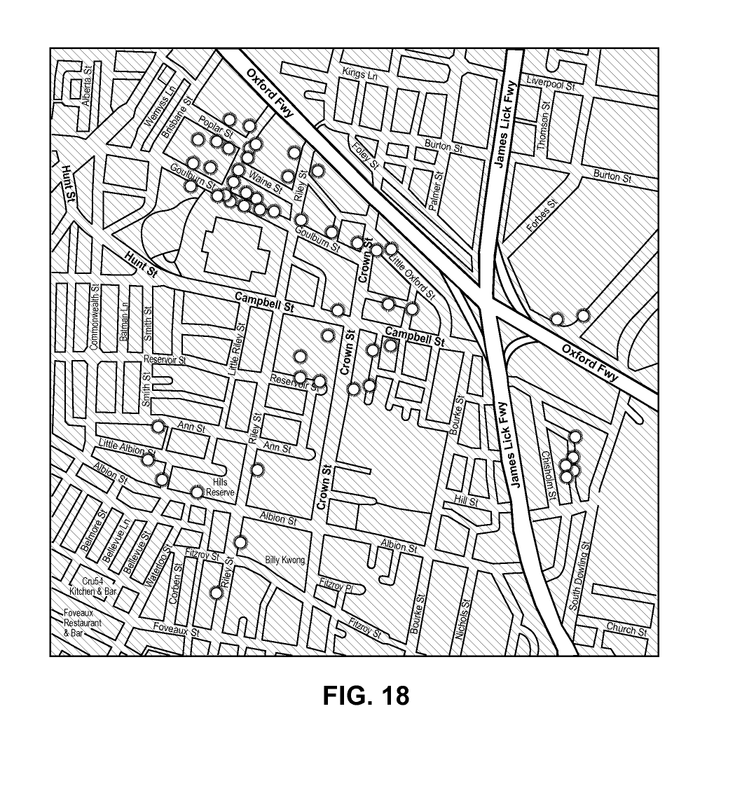

FIG. 18 illustrates another evening or night time display schema according to an embodiment. In particular, the display schema of FIG. 18 may be used to display nighttime illumination. The night illumination may be based on and indicative of evening illumination of streets. Certain display parameters may indicate night illumination such as brightness or color of map features. The night lighting may also be displayed by rendering “street lights” or “light-post” map features on certain roads and areas. In an embodiment, the light fixtures may correspond with actual light sources such as lamp posts and street lights. In some embodiments, the mapping of actual light posts and street lights may be based on satellite or aerial photo captures of a particular location or area.

Generally, illumination during an evening period may be used to indicate several aspects of a map. First, illumination or styles showing illumination may be used to indicate the location of well lit streets for the purposes of navigational safety. For example, a user who is uncomfortable traveling at night may use the illumination styling information to decide to route his trip only through well lit areas for safety and/or ease of navigation. Second, the illumination mapping may be used to determine areas of nightlife. More particularly, well lit areas may represent areas in which one or more points of interest may be located for a given evening period. In an embodiment in which the illumination is current or is based on a live feed of data, the illumination may be used to indicate locations of current evening events such as a concert or other outdoor events. The illumination may also indicate a central business district that is generally well lit. Moreover, night time illumination may also indicate the general presence of populated versus non-populated areas and may be further used to determine navigation options at night. Of course, the uses of a display schema that includes night time illumination include may more examples than those listed. In an embodiment, nighttime illumination may be represented differently for a first set of map features than a second set of map features. FIG. 18 illustrates that small roads and streets may show nighttime illumination using lamp posts and other lamp sources (which, as discussed, may be merely representative of illumination intensity or may correspond with actual light sources) while major highways may indicate illumination based on a color rendering. For example, John F. Foran highway and James Lick Freeway are rendered using a lighter color to indicate stronger illumination.

Generally, FIG. 18 illustrates a display schema that uses darker tones to depict an evening period. Point locations are not labeled using text labels but instead depicted with category symbols. For example, restaurants in FIG. 18 are not labeled by their names but simply indicated by a knife and fork symbol. Similarly, coffee shops are labeled using a cup and saucer symbol. While different sets of display schemas are illustrated in the above figures, it should be noted that the display schemas may be combined in a number of manners and remain within the scope of the described techniques.

Any suitable subset of the blocks may be implemented in any suitable order by a number of different devices (e.g., client or server) and remain consistent with the method and system described herein. Moreover, additional determination blocks may be added to refine the filtering of style parameters subject to interpolation processing.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

For example, the network 25 may include but is not limited to any combination of a LAN, a MAN, a WAN, a mobile, a wired or wireless network, a private network, or a virtual private network. Moreover, while only four client devices are illustrated in FIG. 1 to simplify and clarify the description, it is understood that any number of client computers or display devices are supported and can be in communication with the server 14.

Additionally, certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” or a “routine” is a self-consistent sequence of operations or similar processing leading to a desired result. In this context, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still cooperate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Still further, the figures depict preferred embodiments of a map rendering system for purposes of illustration only. One skilled in the art will readily recognize from the following discussion that alternative embodiments of the structures and methods illustrated herein may be employed without departing from the principles described herein.

Upon reading this disclosure, those of skill in the art will appreciate still additional alternative structural and functional designs for a system and a process for rendering map or other types of images using the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A computer-implemented method for providing map data to a computing device comprising:
receiving, using a computer device, a request for responsive map data, the request including a user time parameter;
retrieving, using the computer device, map data that includes a set of map features representing physical map items wherein each map feature is associated with a style parameter, wherein the style parameter provides information for a map rendering device to render an appearance of the map feature, and wherein each style parameter is assigned a default style;
determining, using the computer device, a set of feature categories of the set of map features, wherein the set of feature categories includes at least a general road, an area, or a location category of map features;
modifying, based on style data corresponding to a time value that matches the received user time parameter, a display attribute of the default style for the set of feature categories of the set of map features; and
providing, using the computer device, access to the set of map features that includes the modified display attribute of the default style for the set of feature categories of the set of map features.

2. The computer-implemented method of claim 1, further including modifying a further display attribute for some of the set of map features belonging to the set of feature categories, wherein the modified display attributes are a subset of a total number of styles that are assignable to the one feature category.

3. The computer-implemented method of claim 1, further including ranking the set of map features based on the user time parameter, wherein map features of the set of map features having a greater relevance to a time value of the user time parameter are ranked higher than map features having less relevance to the time value of the user time parameter and
further modifying the display attribute based on a prominence rating, wherein a degree of prominence of the display attribute increases with increasing rank of the map feature for a given time value of the user time parameter.

4. The computer-implemented method of claim 1, wherein each of the set of map features includes a feature time parameter distinct from the time value that matches the received user time parameter, and
further including ranking the map features by a time difference between the feature time parameter and the user time parameter, wherein map features having a smaller time difference are ranked higher.

5. The computer-implemented method of claim 1, wherein the modified display attribute corresponds to one of an angle or a direction of a display shadow of a map feature, wherein the display attribute is modified based on a function of at least one of the angle or direction of the display shadow and the user time parameter.

6. The computer-implemented method of claim 1, wherein the modified style includes a display attribute corresponds with a temperature-related shade, wherein the display attribute is modified based on a function of the temperature-related shade and the user time parameter.

7. The computer-implemented method of claim 1, wherein the modified display attribute corresponds to an illumination factor, wherein the display attribute is modified based on a function of nighttime illumination of an area of the map.

8. A computer device for pre-fetching map data for a mapping application, the computer device comprising:
a communications network interface;
one or more processors;
one or more memories coupled to the one or more processors;
a display device coupled to the one or more processors;
wherein the one or more memories include computer executable instructions stored therein that, when executed by the one or more processors, cause the one or more processors to
receive a request for responsive map data, the request including a user time parameter;
retrieve map data that includes a set of map features representing physical map items wherein each map feature is associated with a style parameter, wherein the style parameter provides information for a map rendering device to render an appearance of the map feature, and wherein each style parameter is assigned a default style;
determine a set of feature categories of the set of map features, wherein the set of feature categories includes at least a general road, an area, or a location category of map features;
modify based on style data corresponding to a time value that matches the received user time parameter, a display attribute of the default style for the set of feature categories of the set of map features; and
provide access to the set of map features that includes the modified display attribute of the default style for the set of feature categories of the set of map features.

9. The computer device of claim 8, wherein the computer executable instructions, when executed by the one or more processors, further cause the one or more processors to modify a further display attribute for some of the set of map features belonging to the set of feature categories, wherein the modified display attributes are a subset of a total number of styles that are assignable to the one feature category.

10. The computer device of claim 8, wherein the computer executable instructions, when executed by the one or more processors, further cause the one or more processors to rank the set of map features based on the user time parameter, wherein map features having a greater relevance to a time value of the user time parameter are ranked higher than map features having less relevance to the time value of the user time parameter and
wherein the display attribute is modified based on a prominence rating, wherein a degree of prominence of the display attribute increases with increasing rank of the map feature for a given time value of the user time parameter.

11. The computer device of claim 8, wherein each of the set of map features includes a feature time parameter distinct from the time value that matches the received user time parameter, and
wherein the computer executable instructions, when executed by the one or more processors, further cause the one or more processors to rank the map features by a time difference between the feature time parameter and the user time parameter, wherein map features having a smaller time difference are ranked higher.

12. The computer device of claim 8, wherein the modified display attribute corresponds to one of an angle or a direction of a display shadow of a map feature, wherein the display attribute is modified based on a function of at least one of the angle or direction of the display shadow and the user time parameter.

13. The computer device of claim 8, wherein the modified display attribute corresponds with a temperature-related shade, wherein the display attribute is modified based on a function of the temperature-related shade and the user time parameter.

14. The computer device of claim 8, wherein the modified display attribute corresponds to an illumination factor, wherein the display attribute is modified based on a function of nighttime illumination of an area of the map.

15. A computer-implemented method for providing map data to a computing device comprising:
receiving, using a computer device, a request for responsive map data, the request including a user time parameter;
retrieving, using the computer device, map data that includes a set of map features representing physical map items wherein each map feature is associated with a style parameter, wherein the style parameter provides information for a map rendering device to render an appearance of the map feature, and wherein each style parameter is assigned a default style;
modify based on style data corresponding to a time value that matches the received user time parameter, a display attribute of the default style for the set of feature categories of the set of map features; and
providing, using the computer device, access to the set of map features that includes the modified display attribute of the default style for the set of feature categories of the set of map features.

16. The computer-implemented method of claim 15, wherein the modified display attribute corresponds to one of an angle or a direction of a display shadow of a map feature, wherein the display attribute is modified based on a function of at least one of the angle or direction of the display shadow and the user time parameter.

17. The computer-implemented method of claim 15, wherein the modified display attribute corresponds with a temperature-related shade, wherein the display attribute is modified based on a function of the temperature-related shade and the user time parameter.

18. The computer-implemented method of claim 15, wherein the modified display attribute corresponds to an illumination factor, wherein the display attribute is modified on a function of nighttime illumination of an area of the map.

19. The computer-implemented method of claim 15, wherein retrieving the map data includes retrieving raster image data, wherein the raster image data includes a bitmap image corresponding to a time of day and wherein the method further includes retrieving new raster image data based on the user time parameter.

20. The computer-implemented method of claim 15, further including ranking the map features based on the user time parameter, wherein map features having a greater relevance to the user time parameter are ranked higher than map features having less relevance to the user time parameter.

21. The computer-implemented method of claim 20, wherein the display attribute is modified based on a prominence rating, wherein a degree of prominence of the display attribute increases with increasing rank of the map feature at a given time value of the user time parameter.

22. The computer-implemented method of claim 1, further including creating a display schema defined as a set of styles assigned to a set of feature categories, wherein map features belonging to a map feature category are assigned the same style.

23. The computer-implemented method of claim 1, wherein each of the set of map features includes a feature time parameter distinct from the time value that matches the received user time parameter.

24. The computer-implemented method of claim 23, wherein retrieving map data includes retrieving the map features based on matching a value of the user time parameter with a value of the feature time parameter of at least one of the map features.

25. The computer-implemented method of claim 23, wherein retrieving map data includes retrieving map features having associated feature time parameters that are within a threshold of the user time parameter.

26. The computer-implemented method of claim 25, further including ranking the map features by a time difference between the feature time parameter and the user time parameter, wherein map features having a smaller time difference are ranked higher.

27. A computer device for pre-fetching map data for a mapping application, the computer device comprising:
a communications network interface;
one or more processors;
one or more memories coupled to the one or more processors;
a display device coupled to the one or more processors;
wherein the one or more memories include computer executable instructions stored therein that, when executed by the one or more processors, cause the one or more processors to
receive a request for responsive map data, the request including a user time parameter;
retrieve map data that includes a set of map features representing physical map items wherein each map feature is associated with a style parameter, wherein the style parameter provides information for a map rendering device to render an appearance of the map feature, and wherein each style parameter is assigned a default style;
modify based on style data corresponding to a time value that matches the received user time parameter, a display attribute of the default style for the set of feature categories of the set of map features; and
provide access to the set of map features that includes the modified display attribute of the default style for the set of feature categories of the set of map features.
